(19) United States
(12) Patent Application Publication
(10) Pub. No.: US 2015/0326617 A1
(43) Pub. Date: Nov. 12, 2015

(54) Privacy Control Processes for Mobile Devices, Wearable Devices, other Networked Devices, and the Internet of Things

(71) Applicants: Donald Putnam Henry, Menlo Park, CA (US); Charles Marshall, Atherton, CA (US)

(72) Inventors: Donald Putnam Henry, Menlo Park, CA (US); Charles Marshall, Atherton, CA (US)

(73) Assignee: DoNotGeoTrack, Inc., Atherton, CA (US)

(21) Appl. No.: 14/703,743

(22) Filed: May 4, 2015

Related U.S. Application Data
(60) Provisional application No. 61/989,327, filed on May 6, 2014.

(51) Int. Cl. H04L 29/06; H04L 29/12; G06F 21/50

(52) U.S. Cl. CPC H04L 63/205; G06F 21/50; H04L 61/609

(57) ABSTRACT

Mobile devices are increasingly capable of collecting, storing, and transmitting data which may infringe on the security or privacy of others. The inventions disclosed provide methods by which such conflicts may be reduced by allowing geo-graphical areas to be opted-out of certain types of collection, at all or specific times. These methods may help broaden the acceptance of such devices as Google Glass®, other wearable devices, or other mobile collection-capable devices. The disclosure describes a “collection controller” which maintains positive control over a device's collection capabilities. This controller may be paired with an online opt-out registry or sensor which detects coded opt-out beacons. Certain data collected by the device might be metadata tagged and its further use determined by a “data disposition controller” which ensures restrictions on the collected data are maintained and adhered to. Finally, the device may itself be queried to determine if it is controlled by any or all of the processes disclosed in this submission.

### CROSS REFERENCE TO RELATED APPLICATIONS

The present application relates to and claims priority of U.S. provisional patent application (“Copending Provisional Application”), Ser. No. 61/989,327, entitled “PRIVACY CONTROL PROCESSES FOR MOBILE DEVICES, WEARABLE DEVICES, OTHER NETWORKED DEVICES, AND THE INTERNET OF THINGS,” filed on May 6, 2014. The disclosure of the Copending Provisional Application is hereby incorporated by reference in its entirety.

### BACKGROUND OF THE INVENTION

1. Field of Invention

The present application relates to a combination of hardware, firmware, or software used to control privacy breaches by mobile devices, wearable devices, game systems, or devices part of the so-called “internet of things” together with infrastructure to allow owners and users of such devices to control privacy aspects of these devices. The processes described herein selectively restrict the collection, storage, transmission, and metadata labels of information collected by such devices.

2. Discussion of Related Art

The capabilities of networked devices, particularly mobile networked devices, have grown exponentially in the past decade. Devices which previously were used solely for voice communication now include texting, Skyping®, geo-locational services, productivity software, games, full internet access, and recording of sound, still pictures, and video. Wearable devices blur the division between clothing and accessories and such devices. Gaming systems are well advanced from the stand-alone consoles of the past and are usually networked to facilitate multi-player games and handle sensitive information such as credit card numbers. The so called “internet of things” brings connectivity to thermostats, light switches, smoke alarms, automobiles, utility metering, household appliances, industrial machinery, and a multitude of other things.

With these growing capabilities have come growing concerns about the security and privacy problems engendered by these devices. The ability to record sound, pictures, and video are especially problematic. An Ohio man was recently escorted out of a movie theater and detained for hours by the FBI because he was suspected of recording a bootlegged copy of the movie using Google Glass®.¹ Increasingly powerful, cheaper, and more ubiquitous mobile devices with collection capabilities are meeting growing resistance from those with legitimate privacy and security concerns. Such conflicts are likely to become more severe as wearable devices (Google Glass® being just an early example) become more widespread and difficult to identify. As connected devices further penetrate the home and become ubiquitous in daily life, the potential for privacy abuse grows exponentially. Hand in hand with privacy concerns are security concerns: vacant homes can be identified, vulnerable children can be located, connected devices can be sabotaged, etc. ¹ Washington Post, “This Google Glass user went to the movies. Then he got interrogated for about four hours,” Jan. 21, 2014.

There seem to be two current responses to the privacy and security problems posed by these devices. Either such devices are prohibited from certain places or events denying the owners the other functionality of the devices, or people accept degradation of security and privacy such devices represent (i.e., live with them). With the legal regime surrounding such devices uncertain, conflict, including physical confrontation, is almost inevitable between those desiring the functionality afforded by these devices and those desiring to preserve security and privacy. The acceptance of many networked devices will depend of the assurances of those using such devices and those interacting with these users that privacy and security will be protected.

At core of these concerns is the ability of this family of devices to collect, store, label, sometimes process, and disseminate data, whether it is still pictures, full motion video, sound, location, temperature, velocity, flow of energy, water, sewage, or data, or a host of other information, some already collected by networked devices and other not implemented or even imagined. A series of processes which safeguard privacy and security during the use of such devices must provide a method of imposing selective controls on the collection, storage, labelling, processing, or dissemination of such data. Such controls need to be paired with a process whereby users or owners of networked devices and those they interact with can opt-out, limit, trace, become aware of, or otherwise affect the collection, storage, labelling, processing, and dissemination of such data by networked devices. Such processes could be either technological blocking (i.e., video and sound recording prevented at concert) or procedural (i.e., video and sound recording at concert is tagged with metadata identifying the location and time allowing easier scrubbing of such files from YouTube or other sites for copyright or other infringement). Procedural processes could in turn be mandatory or voluntary.

### SUMMARY OF THE INVENTION

This application discloses a process by which privacy and security rights are asserted or preferences are expressed about data collected by networked devices and the collection and use of the collected data are affected by these asserted rights or expressed preferences. The overall process includes two subordinate processes. The first subordinate process is a means by which users or owners of networked² devices or those they interact with them can opt-out, limit, trace, become aware of, or otherwise affect the collection, storage, labelling, processing, and dissemination of such data by networked devices. This first subordinate makes such rights and preferences available to networked devices by one of two methods. In the first, a networked opt-out registry allows owners or users of networked devices or those who interact with them the ability to assert rights or express preferences about the collection, storage, labelling, processing, and dissemination of data by a device and makes these rights and preferences available to hardware, firmware, software, or “cloudware” on or used by the device. In the second method, information about the asserted rights or expressed preferences of owners or users of networked devices or those who interact with them is conveyed by a beacon signal detectable and interpretable by the networked device. The second subordinate process is hardware, firmware, or software on a networked device or “cloudware” used in place of hardware, firmware, or software resident on the device which imposes selective controls on collection, storage, processing, labeling, or dissemination of data by a networked device in response to the rights asserted and preferences expressed in the first subordinate process. ² The term networked here is intended to mean a device connected by wiring or some wireless technology such as radio waves (i.e., Wi-Fi or cellular signal) to a larger group of devices, servers, routers, processors, storage devices, or other devices. The most widespread current implementation of such a grouping is the internet, but intranets and other groupings may supplant or operate in parallel with the internet in the future. Connection may be near continuous or intermittent.

Within this overall framework, numerous types of rights may be asserted or preferences expressed with many different effects on collection, storage, labelling, processing, and dissemination of data by a device. For example, restrictions could be placed based on the time, place, duration, or type of collection of data by a device. Storage could be restricted based on of these factors or any combination of them. Overt or metadata labeling of collected data might be required under certain conditions, and certain processing (such as facial recognition) might similarly be restricted. The dissemination of such data or data derivative of data collected by the device can be prevented, restricted to destination, or dependent on specific labeling (metadata or otherwise).

Finally, a number of ancillary processes can be used to 1) detect the presence or absence of privacy and security protection technology on a device, 2) verify the integrity of such privacy and security protection technology on a device, and 3) detect and or locate devices which either have or do not have such technology present. Such processes could be generic and support multiple purposes or tailored for specific uses (i.e., you need to download specific software to your wearable device to use it on a military base and such software restricts still and video photography, or you need to download specific software to use your wearable device in a popular chain of restaurants or nightclubs which may restrict the use of the device or inform others of the use to which it is being put). Such processes could also include a device registry in which mobile, wearable, or other networked devices are registered as meeting some specific standards for privacy and security protection or for the presence of specific, tailored software programs.

### BRIEF DESCRIPTION OF THE DRAWINGS

FIG. 1 shows overview of opt-out information affecting device behavior

FIG. 2 shows device querying online opt-out registry.

FIG. 3 shows device receiving opt-out beacon signal.

FIG. 4 shows the collection controller linked to a geographic opt-out registry.

FIG. 5 shows beacon alerting device to query opt-out registry.

FIG. 6 shows beacon on device alerting itself to query opt-out registry

FIG. 7 shows networked device using own persistent identifier to query opt-out registry.

FIG. 8 shows alternative responses to locational uncertainty.

FIG. 9 shows a boundary defined opt-out area.

FIG. 10 shows a center and radius defined opt-out area.

FIG. 11 shows an overview of device code functions.

FIG. 12 shows data disposition controller tagging and selectively allowing transfer of data from device.

FIG. 13 shows illustrative opt-out alerts.

FIG. 14 shows the use of an opt-out integrity verifier.

FIG. 15 shows a registry based opt-out integrity process.

FIG. 16 shows a checkpoint or venue device detector characterizing devices by various methods.

FIG. 17 shows the localization of a mobile device by a proximity sensing device.

FIG. 18 shows the localization of a mobile device by triangulation from multiple directional sensing devices.

FIG. 19 shows the localization of a device by triangulation from multiple readings from a single, moving, directional sensing device.

FIG. 20 shows device number and status in venue.

FIG. 21 shows preset privacy and security settings for specific venues or organizations.

FIG. 22 shows venue or organization custom or proprietary code interacting with device privacy and security controls.

### DETAILED DESCRIPTION OF THE PREFERRED EMBODIMENTS

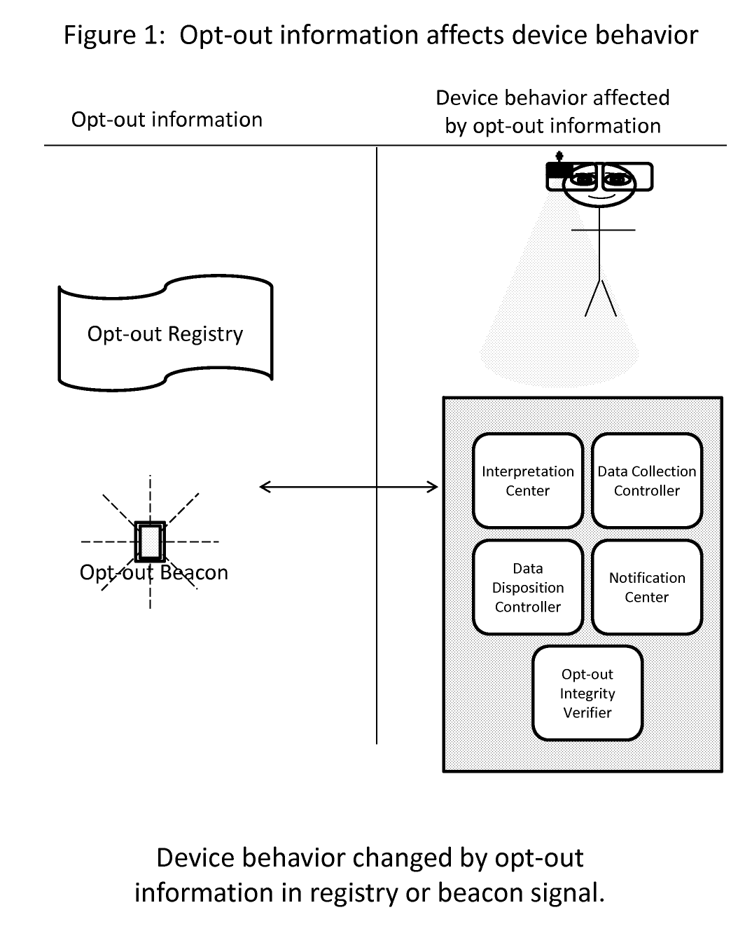

This application discloses a process by which privacy and security rights are asserted or preferences are expressed about data collected by networked devices and the collection and use of the collected data are affected by these asserted rights or expressed preferences. The overall process includes two subordinate processes. In the first, such rights and preferences are asserted and expressed and made available to devices. In the second, the data collected by such devices or its use and disposition is affected by these asserted rights and expressed preferences. (See FIG. 1.)

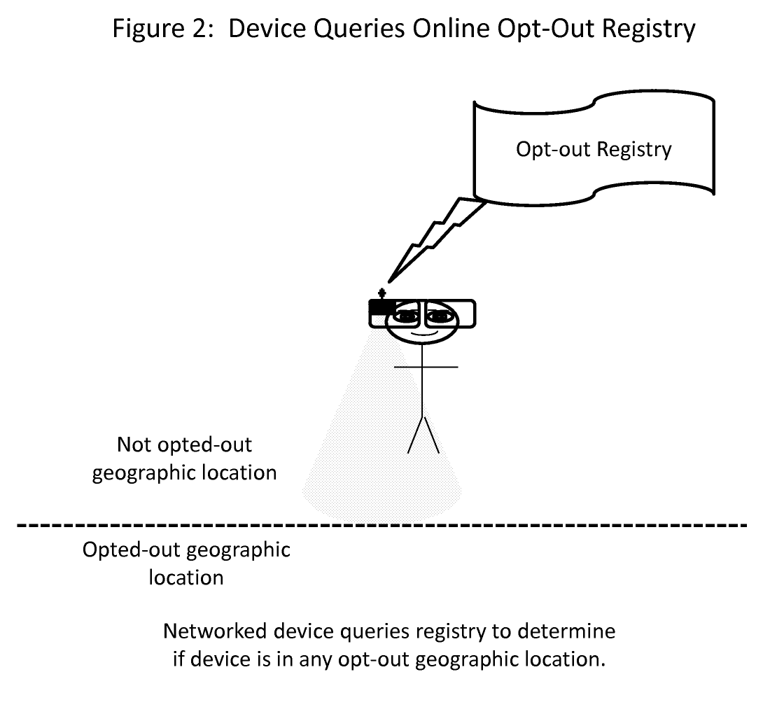

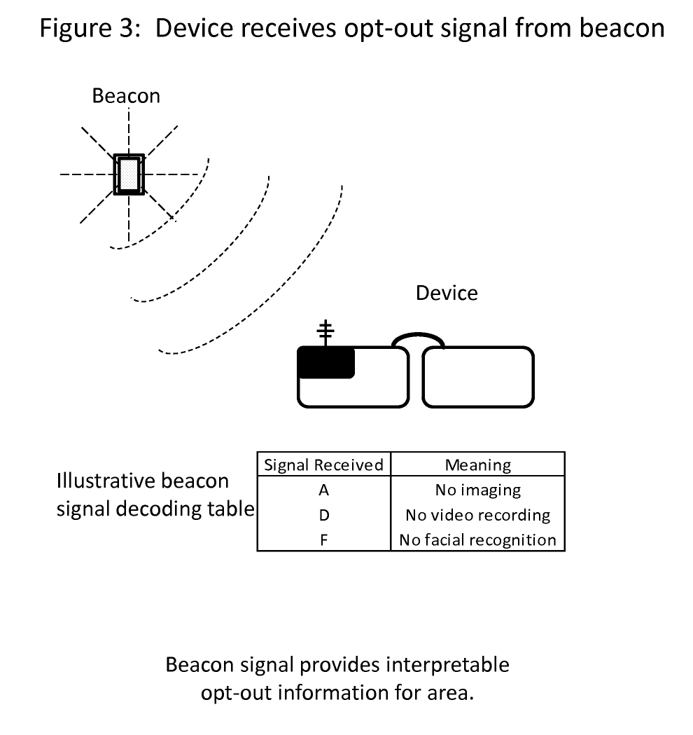

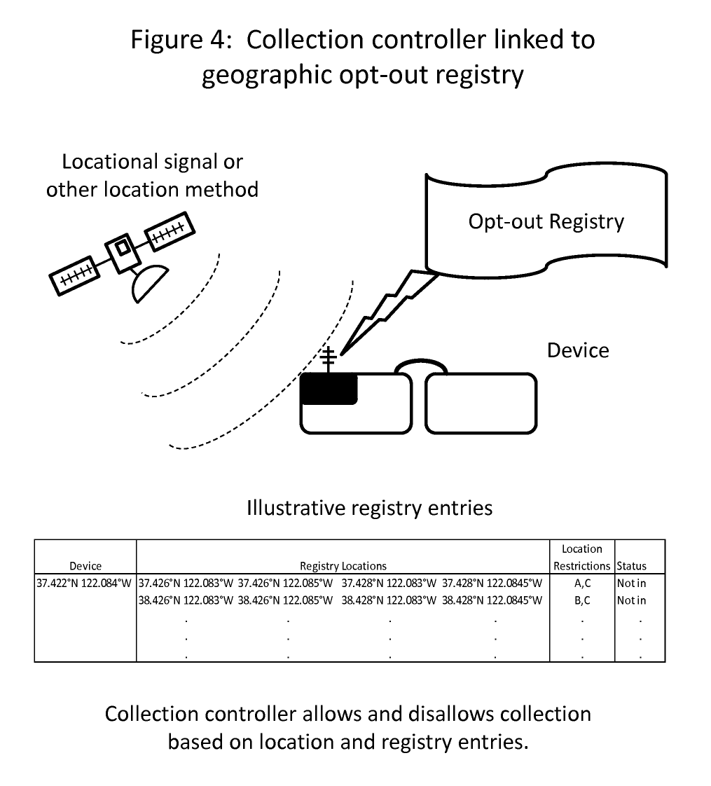

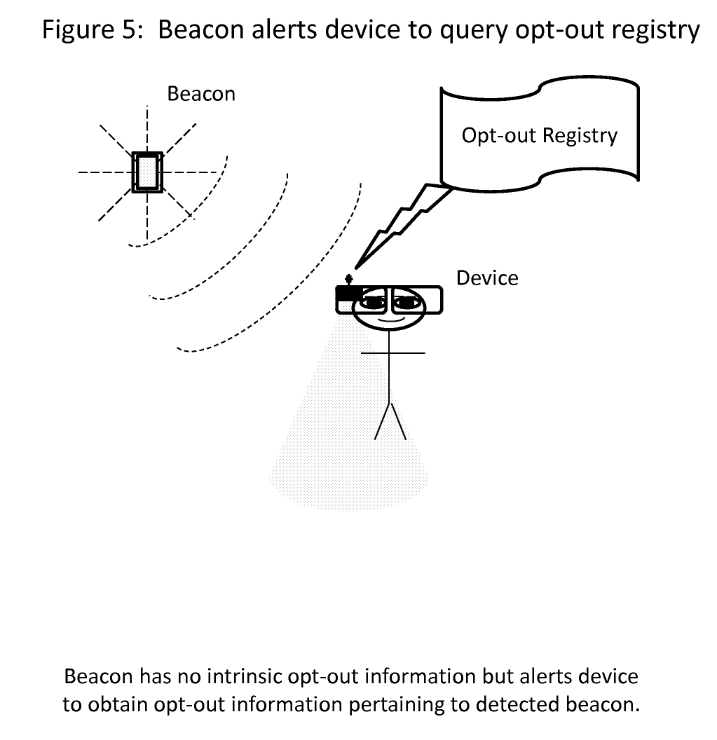

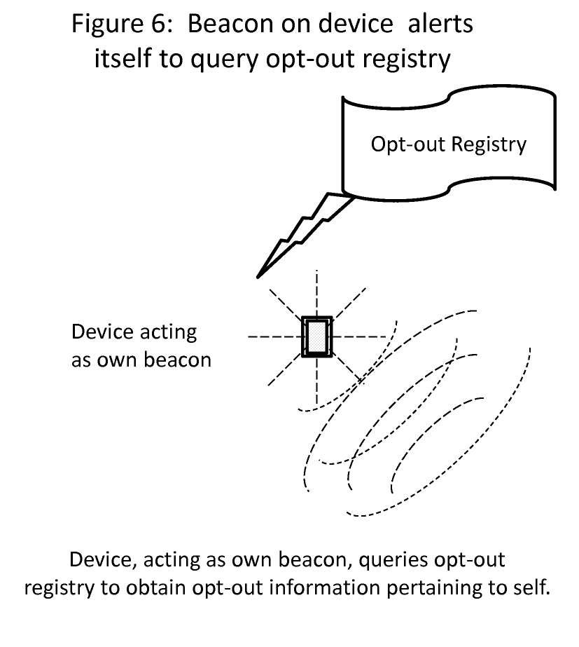

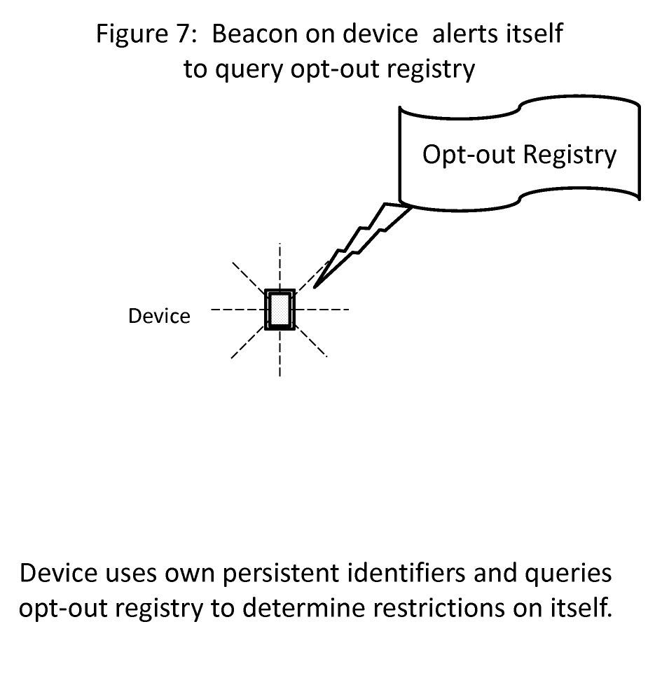

There are two alternative embodiments of the first subordinate process. In the first embodiment, owners or users of a networked device or those who interact with them assert rights or express preferences through an online opt-out registry where information in the registry can be accessed by the networked device. (See FIG. 2.) Normally, a device will query the online opt-out registry and include its geographic location in the query. The registry will return data pertaining to that location. In the second embodiment, a pre-programmed or programmable beacon emits a signal which is detectable and interpretable by a device and the beacon signal contains information on the rights expressed or preferences asserted by the user of the beacon who may be an owner or user of a device or someone who interacts with the owner, user, or device. (See FIG. 3.) The first embodiment works only in locations where a network device has some access to the network and the device can determine its own location. (See FIG. 4.) The second embodiment works in any location and even for devices which can receive and interpret a beacon signal but are not themselves networked. A blend of these two embodiments might be used wherein a beacon signal might only identify that beacon and a device accesses an online opt-out registry to determine which rights are asserted or preferences expressed by the user of the beacon. As a specific example, every smart phone transmits or is capable of transmitting its MAC (media access control) Address which is used in accessing local Wi-Fi networks. This address is unique and can serve as an identifying beacon. A second device, upon detecting this signal, can query the online opt-out registry to determine the rights asserted and preferences expressed. (See FIG. 5.) This blended method could be used in a location where a device cannot determine its own location with sufficient fidelity to act on an opt-out right or preference, for example, deep inside a building. This blended method could even be used by a device owner or user to control his or her own device if the method the device uses to receive the identifying signal can receive its own signal or determine its own signal and query the online opt-out database accordingly. (See FIG. 6.) A simple version of the process might be used for internet of things type devices among others. A device queries the online opt-out registry to determine restrictions arising from rights asserted and preferences expressed that apply to it. For example, the owner of an internet thermostat might assert a right or express a preference (depending on the legal and regulatory environment) that information on the temperature setting be disclosed only to the owner and no third parties. In another example, a utility “smart meter” might have the home or business owner assert a right or express a preference that the data collected by the meter be used only for billing purposes and not be disclosed to any other party for any other use. (See FIG. 7.)

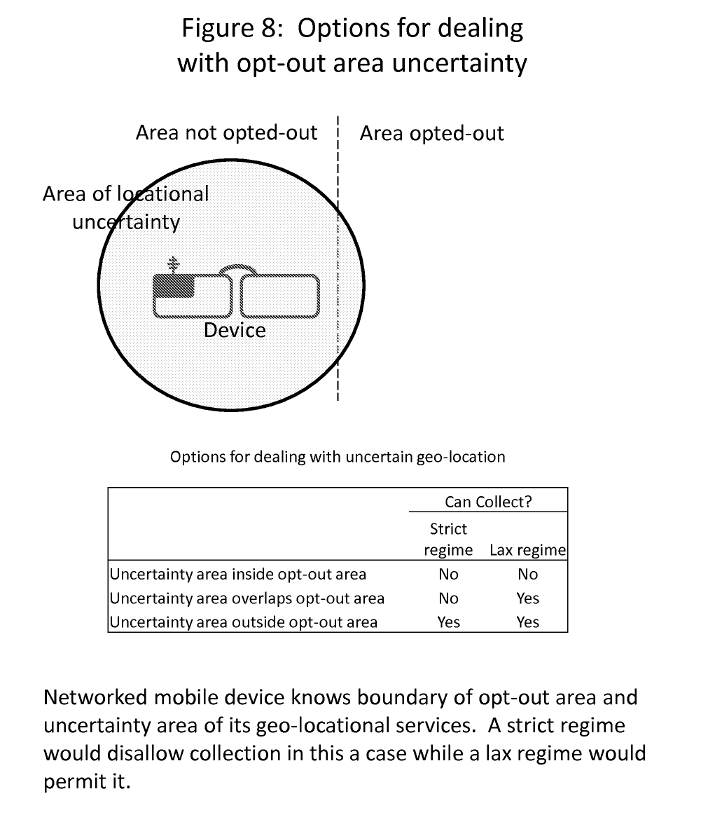

The sort of opt-out information which might be conveyed by any of these embodiments is quite flexible and may be both detailed and complex. In a simple embodiment, an opt-out registry or beacon might be used to convey restrictions on a type of data collection at a particular location. For example, the owner of a movie theater might assert a right or express a preference to prohibit video and sound recording within the theater. The owner might limit such restrictions just to times when a movie is actually playing either by including show times in the opt-out registry or by turning the beacon signal off when no movie is showing. A sports venue might allow still photography where the imaging lens is focused no more than a certain distance from the device, allowing attendees to photograph themselves and friends at the venue but not the sporting event. An event organizer might prohibit any sort of photographic or sound recording providing exceptions for those who pay a license fee or agree to upload these recordings only to a specific site where they might be used by the organizer (authorizing unofficial cameramen), possibly sharing royalties with the device user. When there is locational uncertainty for the device, a variety of responses is possible. (See FIG. 8.)

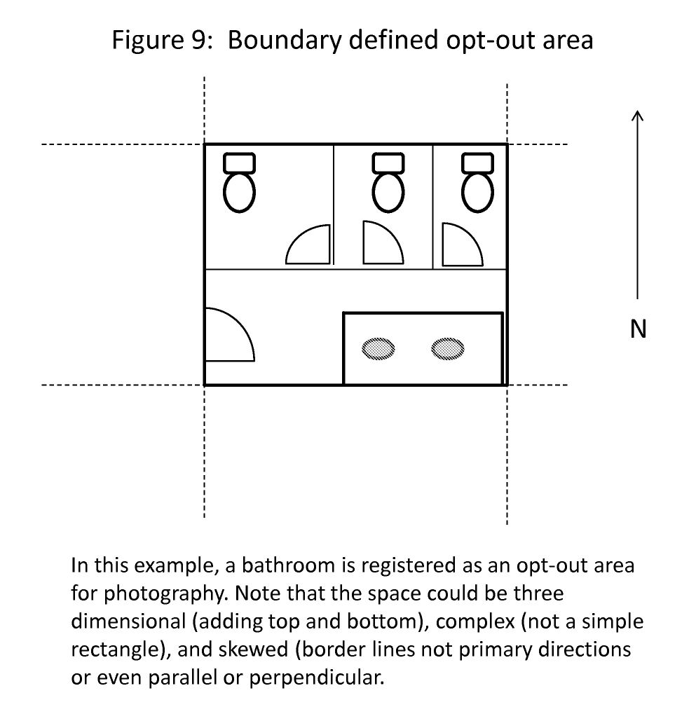

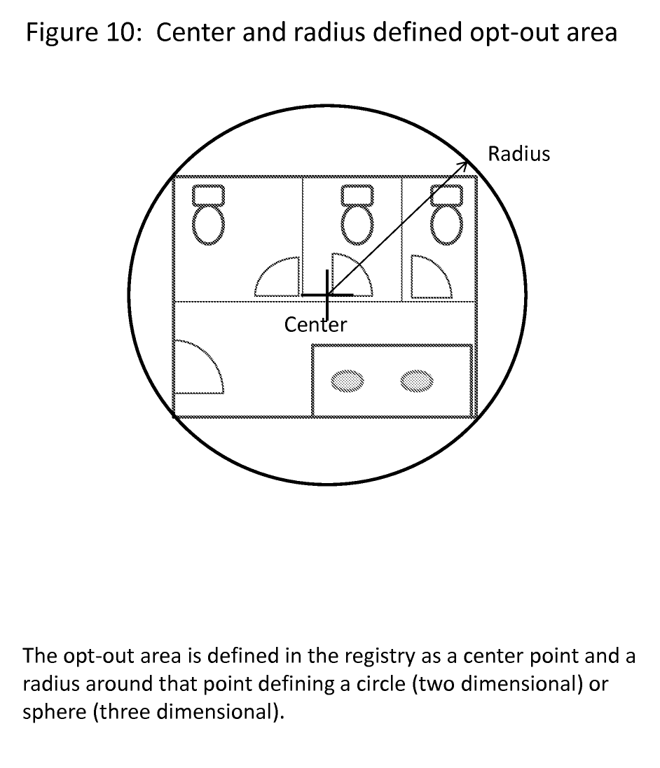

The opt-out information, whether made available to devices by either method can include restrictions on place, time, types of collection, storage or onboard processing of data, labelling of data (overt or metadata tags³), or dissemination of data. Dissemination control, particularly when paired with metadata tagging, can be used to detect or restrict further use of the data (i.e., a restriction that the data cannot be used for facial recognition or video of a concert cannot be posted online). A casino or conference venue might, for example, allow unlimited audio and video recording but restrict dissemination off the collecting device and any storage once the device has left the neighborhood of the casino or conference (the “What goes in Vegas stays in Vegas” type restriction). Locational based restrictions (by themselves or combined or qualified by other restrictions such as time) can be based on boundaries (two or three dimensional) (see FIG. 9) or by a point and radius (again two or three dimensional) (see FIG. 10). ³ Overt tagging is detectable in native format while metadata tagging would not. Overt tagging is akin to the old commercial photographer's “Proof” visible in images provided to customers for review but removed after final purchase. Overt tagging of video recording, for example, would include time and location information in the video and visible to viewers. Metadata tagging would include such information with the video data but not directly visible to viewers.

The management of an opt-out registry with geographic restrictions may require some additional processes to ensure its integrity. A registrant might be required to verify an interest in the space he or she is attempting to register as opted-out of some form of collection. That verification might be a proof of ownership or rental of a location, a contract to hold an event at a location, or some other method of verifying interest. In order to prevent abuse (i.e., to prevent a celebrity from opting-out the street area outside a restaurant which he or she plans to visit), certain spaces could be restricted from opting-out. For example, still and video photography is generally allowed in open public places (streets, parks, highways). In other places, state and local laws may govern certain types of collection (and the registry could either flag entire jurisdictions as either opted-out of certain types of collection or not eligible for opting out. Additionally, certain types of facilities might be opted-out of collection: museums, funerals, courtrooms, military facilities, etc. Finally, the accuracy of the device geo-locational capability will need to be considered, a parameter which may vary by device, location, meteorological conditions, and the current locations of the array of GPS satellites.

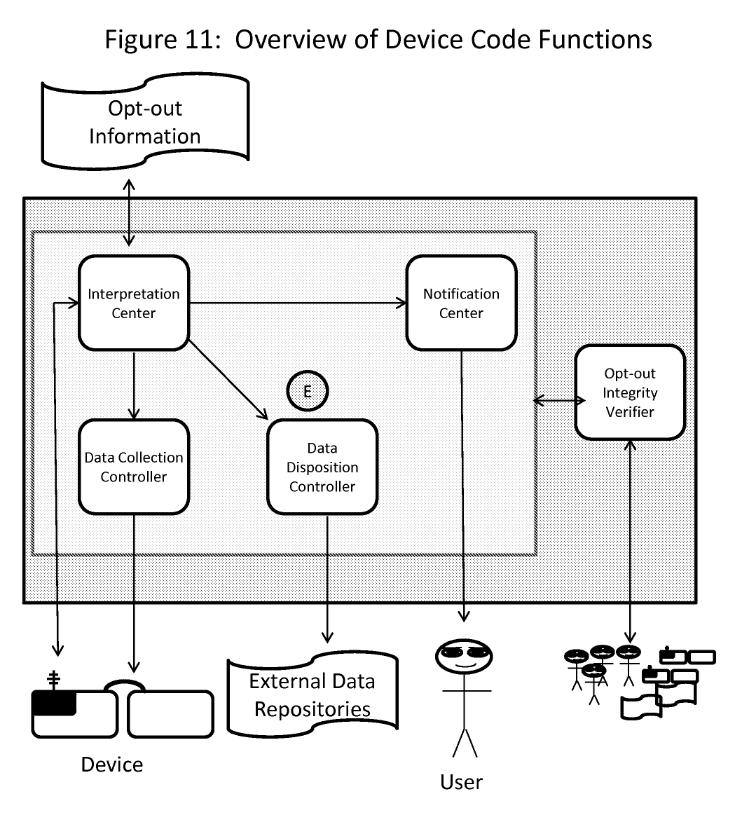

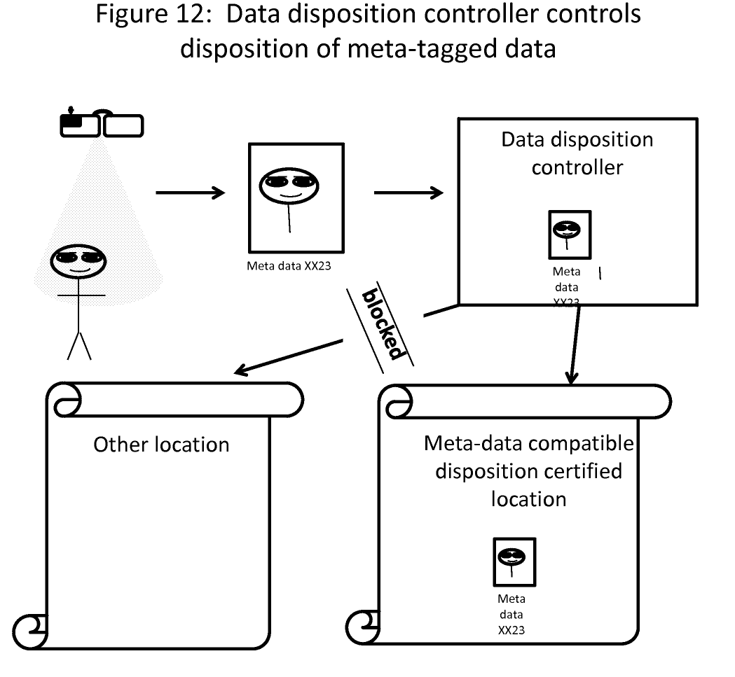

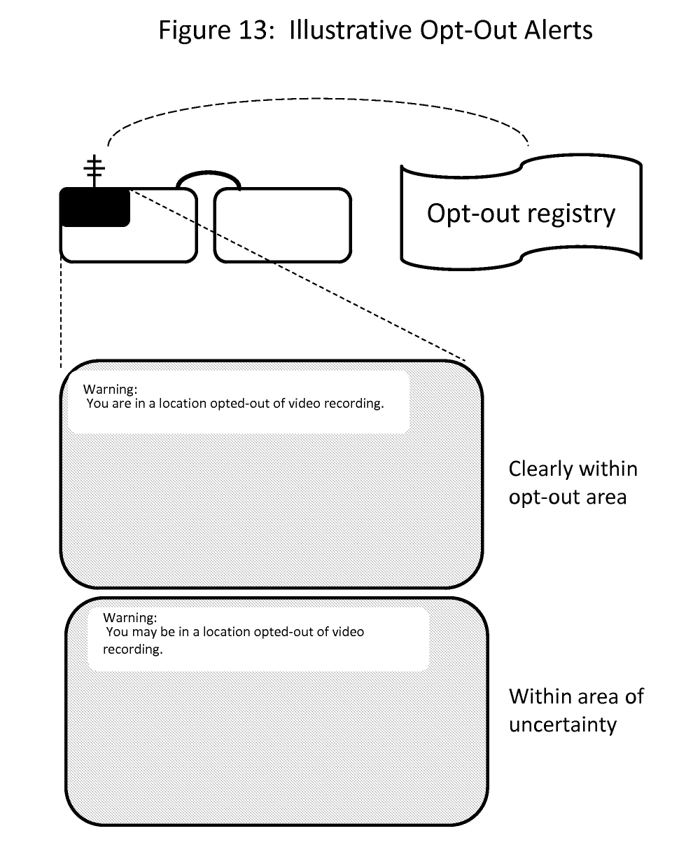

In the second subordinate process, hardware, firmware, or software on a device or “cloudware” used in place of hardware, firmware, or software resident on the device (hereafter collectively called “code”) imposes selective controls on collection, storage, processing, labeling, or dissemination of data by a networked device in response to the rights asserted and preferences expressed in the first subordinate process. There are five primary functions that may be performed by the code. (See FIG. 11.) First, the code must have a module⁴ which interprets the rights asserted and preferences expressed through the opt-out registry hereinafter referred to as the “interpretation center.” Second, the code may prevent or restrict collection of certain types of data. The module which accomplished this function will hereinafter be referred to as the “data collection controller.” This module may include a function which prevents collection unless communications channels which allow provide access to the opt-out registry is open and/or the sensor which detects opt-out beacons is on. This module may also include a function which requires an externally detectable signal to be emitted by the device when collecting data (which might include information on the type of collection, collection parameters (such as the direction of collection for data with a directional component such as photography) and the device identity. Third, the code may prevent or restrict the use (storage, processing, labelling, or dissemination) of the data and derivative data it does collect and this module will hereinafter be referred to as the “data disposition controller.” (See FIG. 12.) Fourth, the code may include a module which notifies the user or owner of the device of rights asserted or preferences expressed which may apply to the device⁵ hereinafter referred to as the “notification center.” (See FIG. 13.) Finally, the code may include a module which helps verify that privacy and security protecting features have been installed a device and have not been tampered with. (This last function may also be accomplished through other means described below.) ⁴ The term module here is used functionally to denote those parts of the code which perform a particular function. Nothing here should be taken to imply that such modules may not share code or access common code.⁵ Notification here normally would mean notification through a user interface incorporated in or attached to the device but could also mean notification of the user or owner through a different device with a user interface.

Not every embodiment of the second subordinate process need have all five components. Any embodiment will, however, have at least the interpretation center and one of the next three controllers. For example, a device with only the interpretation center and the data collection controller would stop restricted types of collection in areas so identified by an opt-out registry or beacon signal. A device with the interpretation center and the data disposition controller would allow collection of data but implement restrictions on the further use of that data and derivative data (i.e., delete after certain period of time, place overt or metadata labels on data, restrict types of processing locally, or prevent or restrict dissemination of data). Finally a device with the interpretation center and a notification controller would allow unimpeded collection and use of the data but inform the user of any asserted rights he might be infringing upon or preferences he may be disregarding. Compliance, if any, would be the responsibility of the user.

One problem with controlling wearable devices and other mobile devices is that they are relatively hard to detect. While Google Glass® may have a distinctive look, other small or wearable devices may be harder to differentiate from similar articles of clothing or accessories. Most cell phones and other mobile devices are easy to conceal. Because of this difficulty, many businesses, other venues, and homes have difficulty excluding or otherwise controlling these devices. Nor will those wishing to exclude or control such devices have easy ways of differentiating between various versions of such devices which may have different capabilities engendering different privacy and security concerns.

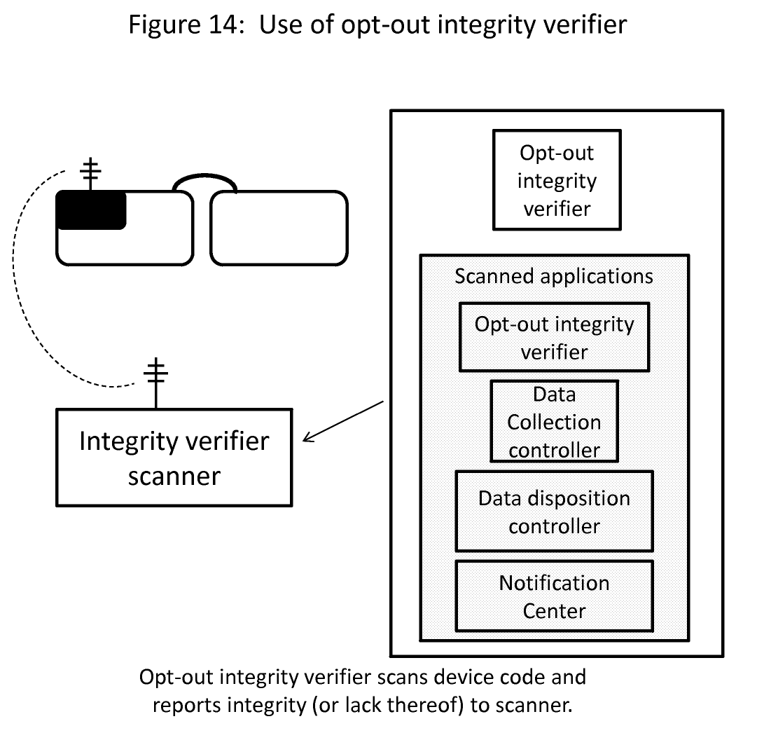

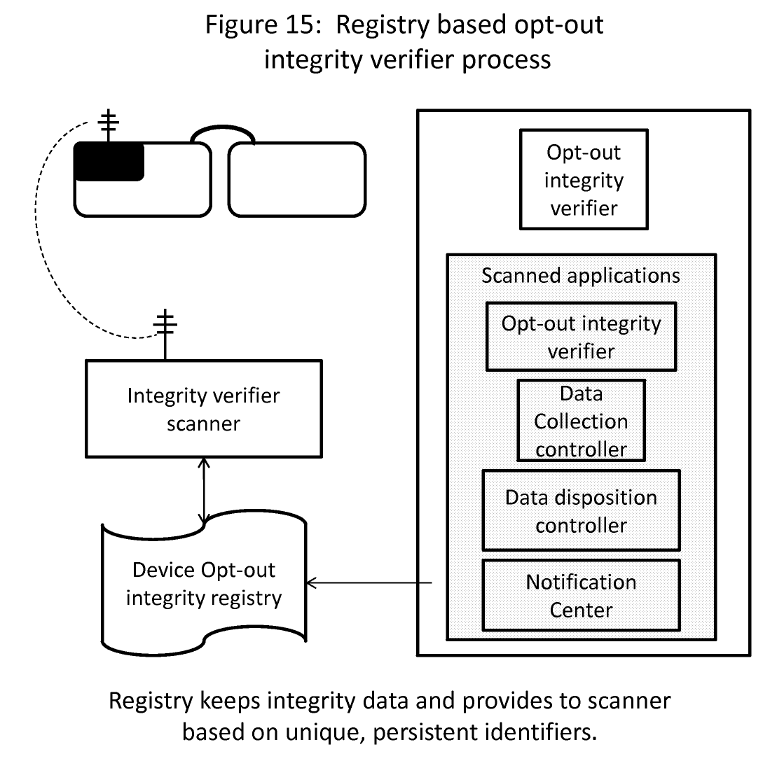

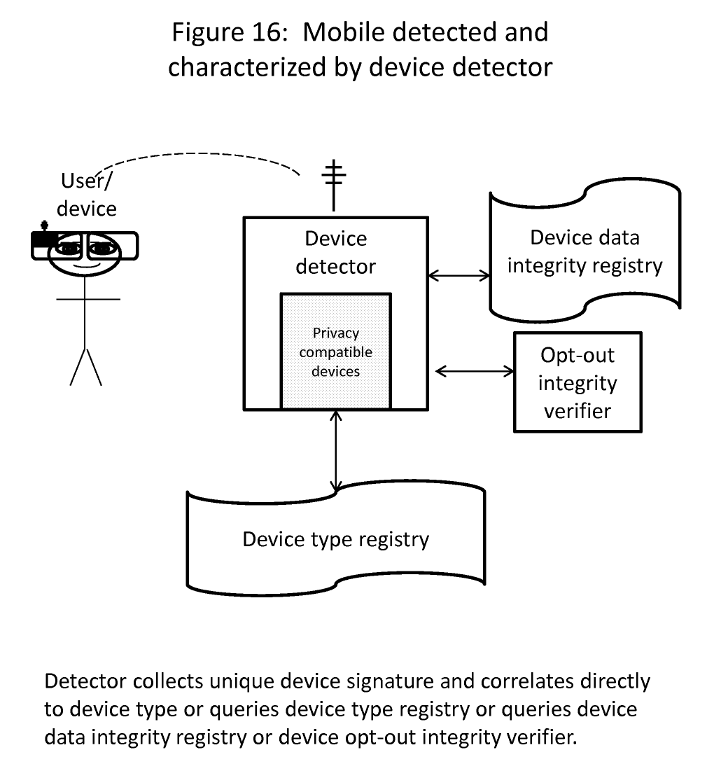

The acceptance of mobile devices, particularly but not limited to wearable devices, in many venues requires some assurance on the part of the owner, operators, and users of the venue and others who are in the venue that proper privacy controls are present on the device, not tampered with, and operational. An enhancement of the methods above may provide a means of verifying that a mobile device is equipped with the some or all of the control features described above. For a device with no changeable software, such confirmation could be visible (a logo or indicator on the device that says it meets certain standards for controlling collection in opted-out areas. For other devices, a query, perhaps IR or RF signal, might be sent to the device. Some part of the code used by the device (hardware, firmware, software, or “cloudware”) in the operating system, the application program interface (API), or an application on the device would be able to determine both the presence and integrity of the collection controller and data disposition controller on the device. This “opt-out integrity verifier” module would, through a series of check-sums and other verification algorithms determine, with a high degree of certainty, that the device opt-out functionality is present and not tampered with. If the code so such upon receiving a query, it would respond with a signal, perhaps encoded, which verifies the opt-out integrity. (See FIG. 14.) Alternatively, the opt-out integrity verifier module could be paired with an on-line registry of privacy and security compliant devices. (See FIG. 15.) The opt-out integrity verifier would periodically perform checks on the device and itself and communicate to the registry the presence and status of the above and other related privacy and security controls along with one or more externally detectable persistent identifiers for the device (including but not limited to the identifiers used for cellular communication, the MAC (Media Access Control) address, the Bluetooth Address, etc.) A venue could scan for these identifiers at an access screening point (door, gate, road checkpoint, etc.) or scan parts or the entire venue for detectible these detectible identifiers and use the detected signal to locate devices which do not meet the venue standards. (See FIG. 16.) The characterization could be accomplished by the characterizing the device itself if the device does not support privacy and security protections or if such protections are a permanent, unalterable feature of the device. Otherwise, the device would be characterized by direct query to the opt-out integrity verifier or to a device opt-out integrity registry.

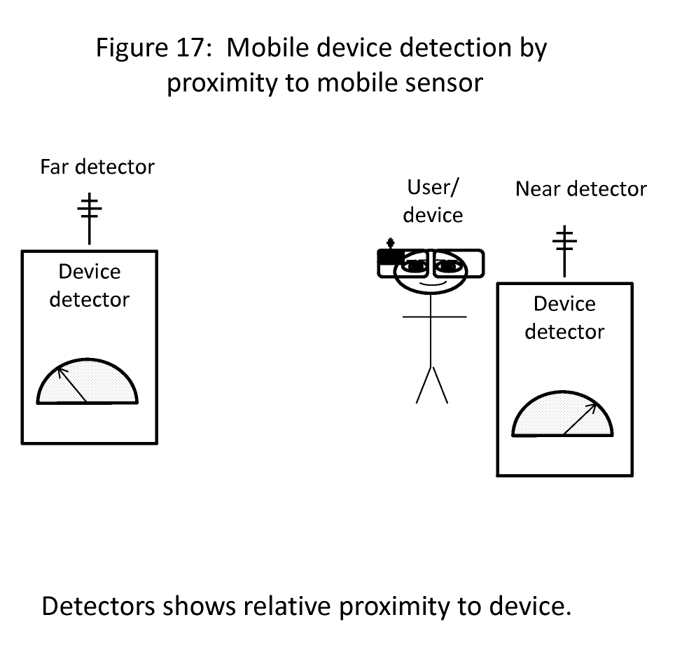

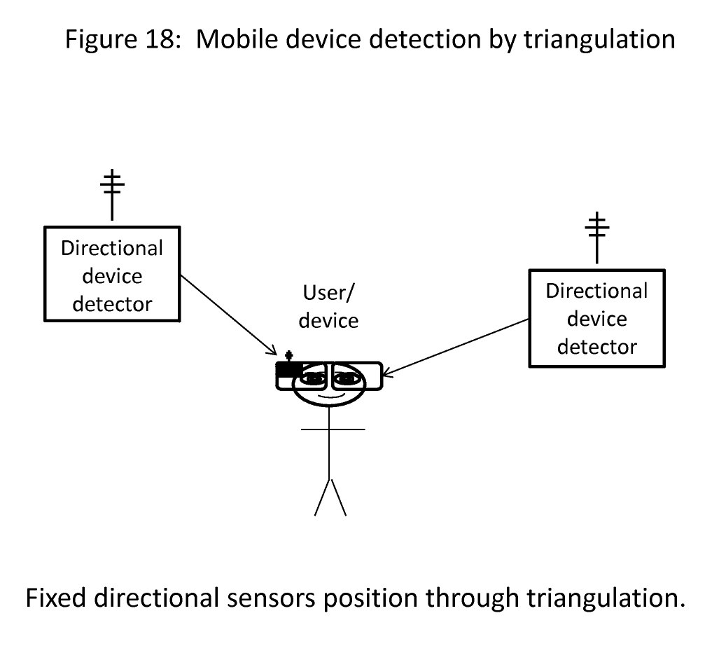

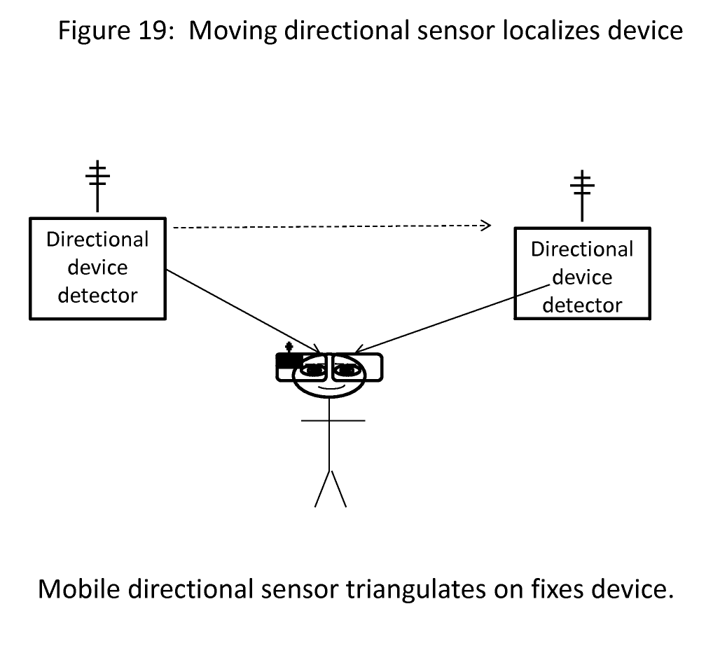

Specific devices could be located in a venue to enforce privacy and security restrictions. For example, a person might turn off a device and conceal it to enter a movie theater. If that person subsequently turns the device on within the theater, perhaps to wrongly collect data, the device can be localized through several methods, all roughly based on triangulation. (See FIGS. 17, 18, and 19). The venue, with proper equipment, could choose to take action only against those devices which do not have appropriate privacy and security protection controls.

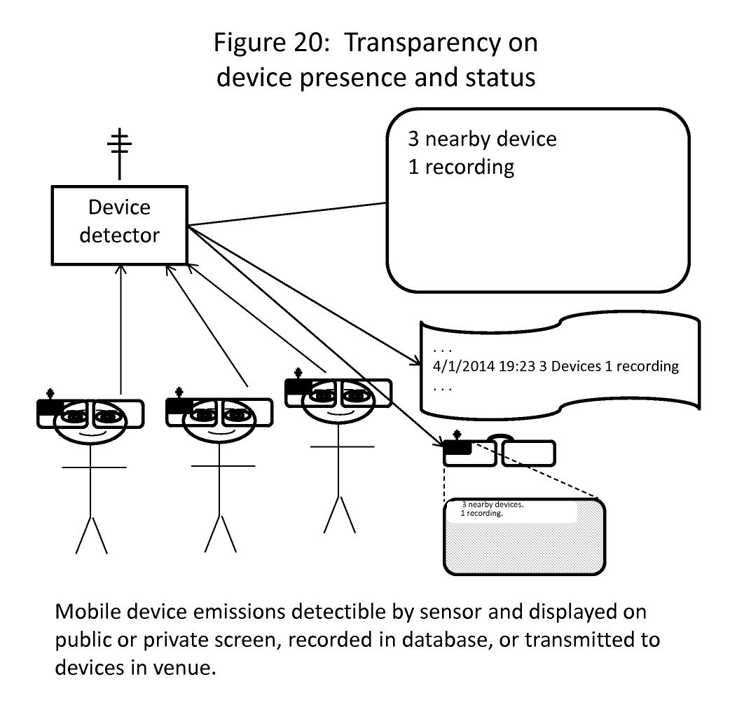

The use of such technologies by a venue provides insights to the venue and its operators of the numbers, types, and general location of data collection capable devices and similar information on those currently collecting data. Such information could be made available to those in the venue through a public display or through a web site or app on other mobile devices. Such information could alert a venue patron or mobile device user when it is possible that data might be collected on them and when it is actually being collected. (See FIG. 20.)

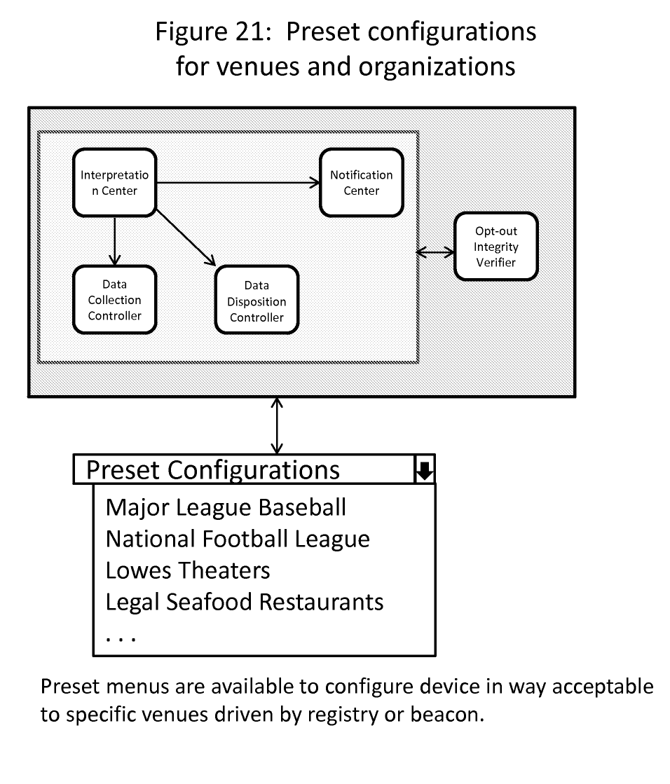

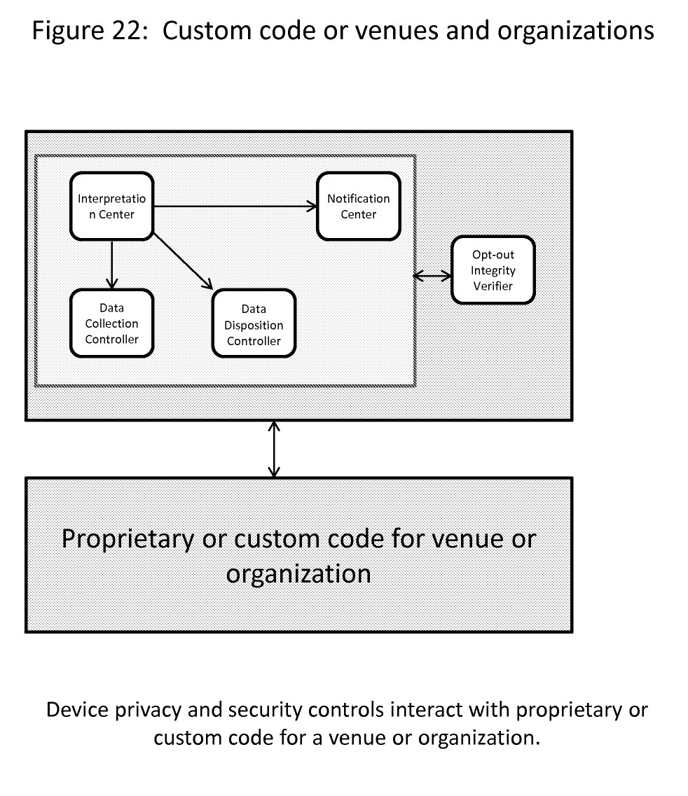

The above methods can be used in a stand-alone fashion or integrated with other code and technologies. For example major league sports league often severely restrict the video and sound recordings (and sometimes still photography) of their events. Code which embodies the above methods could interact with an application or other code developed or adopted for a specific venue, a group of venues, and organization, or group of organization. Alternatively, the code which embodies the above methods could be configurable to accommodate the requirements of such entities. There could pre-set menus of configurations for such software for certain venues or organizations. For example, there could be a pre-set configuration for Major League Baseball, for Lowes Theaters, and for Legal Seafood Restaurants. These configurations could be selectable by a user or determined by complementary code developed for or adopted for venues or organizations. (See FIGS. 21 and 22.) For example, the Lowes Theater code or preset could trigger the imposition of a configuration which disables video or sound recording whenever the device is within a Lowes theater when a movie is showing. A Major League Baseball code or preset might trigger the imposition of a configuration which metadata tags any video or still photography with date, time, and location information or a tag which identifies it as being taken at the location of a baseball game during a game. Such metadata tagging would facilitate automated screens of social media and other sites for uploads which infringe on rights asserted by the league. The Legal Seafood code or preset might require that devices emit a signal that when they are on or when they are taking still or video photography. Such a signal might be used to provide alerts to other patrons that they may be having their picture taken or video recorded.

Some proposed and demonstrated uses of wearable or portable devices could be considered assistive technologies for those with disabilities. Some of the restrictions a venue, organization, or other entity might want to impose on such devices may run counter to legal requirements under the Americans with Disabilities Act of 1990, state and local laws and laws and regulations, common sense and courtesy. For example, a visually impaired person might use text recognition capabilities of a wearable device to convert text into speech. Such a use would require use of a camera. A deaf or hearing impaired person might use a voice recognition capability converting sound to text. This use requires the use of a microphone. Both cameras and sound recording might ordinarily be banned in a venue. To allow for accommodations for those with disabilities and difficulties, a device registry could be used, and the restrictions normally imposed on a device could be modified to allow the device functionality. Creative use of the methods described above could tailor such modifications to retain the assistive functionality of the device while preserving, as much as possible, the interests of the venue, organization, or other entity in restricting the use of the device. For example, in a location where still and video photography is restricted, a device registered to a blind person could have the cameras enabled with the data collected from the cameras used only by the text recognition function and then deleted. Similarly, microphones could be enabled for voice recognition use only. Other uses for wearable and mobile devices will certainly arise, and means of accommodating needs of those with disabilities and difficulties can be developed around the method of registering the device and needed accommodations in an online device registry. Alternatively, devices used by those with disabilities and difficulties could programmed to include code which supports pre-planned accommodations. Such pre-planned accommodations could be recognized as an allowed variant of the privacy and security protection code by the opt-out integrity verifier.

What is claimed is:

1. A method whereby the information collection capabilities, including but not limited to still and video photography and sound recording, are positively controlled through computer code built into the hardware of a mobile device, firmware or software resident on the device, or “cloudware” accessed by the device (hereinafter referred to as a “collection controller”).

2. A specific embodiment of claim 1 whereby a geographical opt-out registry is linked to the collection controller on the device preventing or limiting types of collection which, according to the registry, are not allowed, opted-out of, restricted, caveated, limited in use (i.e., cannot be used for facial recognition, can only be transferred to certain other devices, etc.) or require metadata tagging for current location of the mobile device.

3. A specific embodiment of claim 1 whereby the collection controller is linked to a sensor on the device which detects opt-out beacon signals (including but not limited to visual light, IR, and RF signals) preventing or limiting types of collection which, according to the beacon signal, are not allowed, opted-out of, restricted, caveated, limited in use (i.e., cannot be used for facial recognition, can only be transferred to certain other devices, etc.) or require metadata tagging in the vicinity of the beacon.

4. A refinement of claim 2 wherein the collection controller requires geo-locational and networking services to be active (turned on) before collection is permitted.

5. A refinement of claim 3 wherein collection is disallowed unless the beacon sensor is active (turned on).

6. A method whereby computer code built into the hardware of the device, firmware or software resident on the device, or “cloudware” accessed by the device (hereinafter referred to as a “data disposition controller”) maintains positive control over the metadata tagged information on the device preventing such information from being offloaded from the device or used on the device in a way contrary to the restrictions or caveats in the metadata tags.

7. A specific implementation of claim 6 wherein the data disposition controller deletes certain metadata tagged data after a specific date and time or interval.

8. A specific implementation of claim 6 wherein the data disposition controller prevents the metadata tagged data from being offloaded from the device.

9. A specific implementation of claim 6 whereby the data disposition controller allows offloading the data only to locations which will maintain the metadata tags and continue to positively control the data consistent with the restrictions or caveats in the metadata tags.

10. A specific implementation of claim 6 whereby the data disposition controller restricts the use of the metadata tagged data only to certain applications on the device to access or change the data (for example to prevent stripping the metadata tags or bypassing the data disposition controller).

11. A method whereby computer code built into the hardware of the device, firmware or software resident on the device, or “cloudware” accessed by the device (hereinafter referred to as an “opt-out integrity verifier”) allows an external query of the device to launch a series of tests to ensure that the collection controller and/or the data disposition controller are active on the device and not tampered with and then returns a response to the query either verifying that the device is controlled by such opt-out technologies or that such cannot be determined.

12. A variation claim 12 wherein a device which has the “collection controller” or “data disposition controller” code permanently and inalterably resident in the device is identified through a logo or other visual distinguishing feature.

13. A variation of claim 1 whereby computer code built into the hardware of the device, firmware or software resident on the device, or “cloudware” accessed by the device queries a geographical opt-out registry or interprets signals from a beacon and alerts the user to the restrictions (or opted-out status) of his or her current location. Such an alert may be visual, audible, or tactile (such as vibration) depending on the device.

14. A variation of claim 13 whereby a user is alerted when requesting the device collect data where such collection is restricted (or opted-out). Such an alert may be visual, audible, or tactile (such as vibration) depending on the device. Such an alert may be merely an alert or delay the requested collection until the user confirms his request to collect data, the knowledge of restrictions or opt-out status notwithstanding.

15. A refinement of claim 2 wherein private or governmental property owners, renters, or others with an interest in a location or a location during a specific time frame register that area as opted-out of certain types of collection, that requires controls on such collection by mobile devices, or limits uses or disposition of such data if collected in an online geographical opt-out registry. Such location can be identified by a single point and radius (in two or three dimensions) or by boundaries (again in two or three dimensions).

16. A refinement of claim 15 wherein a geographical opt-out registry can proscribe certain types of opt-out registration when opting-out is not allowed for specific types of collection (i.e., for public roads and parks for still and video photography).

17. A variation of claim 15 wherein local or state regional or other jurisdiction laws and regulations can be reflected in a geographical opt-out registry by either disallowing opting-out for certain types of collection for those jurisdictions or automatically opting-out entire jurisdictions for certain types of collection.

18. A variation of claim 17 wherein various logical rules are applied within a local or state jurisdiction based on local laws and regulations rather than applying rules to the entire jurisdiction (i.e., opting-out of certain types of collection within 200 feet of any school in a particular jurisdiction).

19. A further embodiment of claim 13 wherein the alert provided the mobile device user is paired with or substituted by a consent agreement whereby the user acknowledges and agrees to abide by the restrictions on collection imposed in the area for which the alert is made and reminds the user if the user has previously consented to such restrictions.

20. A refinement of claim 15 in which opt-out restrictions imposed by a venue, organization, or other entity on a wearable, mobile, or other device can be overridden or modified for those with disabilities or difficulties by exempting devices used by such individuals from certain restrictions or by modifying the restrictions in a manner which accommodates the user while preserving, to the extent possible, the interest of the entities imposing the restrictions.

21. A specific embodiment of claim 20 in which the accommodations are available in a device registry.

22. A specific embodiment of claim 20 in which the accommodations are made through changes in the privacy protection and security code used by the device and such changes are recognized as an authorized variant in general or for that specific device in any process designed to verify the presence and lack of tampering of code.
